(19) United States
(12) Patent Application Publication
(10) Pub. No.: US 2017/0017114 A1
(43) Pub. Date: Jan. 19, 2017

(54) LIQUID CRYSTAL DISPLAY DEVICE

(71) Applicant: Samsung Display Co. Ltd., Yongin-si (KR)

(72) Inventors: Nak Cho CHOI, Hwaseong-si (KR); Jong Hak HWANG, Yongin-si (KR); Su Wan WOO, Osan-si (KR); Yeo Geon YOON, Suwon-si (KR); Je Hong CHOI, Suwon-si (KR)

(21) Appl. No.: 15/063,113

(22) Filed: Mar. 7, 2016

(30) Foreign Application Priority Data
Jul. 16, 2015 (KR) 10-2015-0100847

(51) Int. Cl. G02F 1/1335; G02B 1/04; G02F 1/13363

(52) U.S. Cl. CPC G02F 1/133528; G02F 1/13363; G02F 1/133512; G02B 1/04; G02F 2001/133548

(57) ABSTRACT

A display device may include a lighting unit, a transparent substrate, a liquid crystal layer, a polarizer, and a plurality of fillers. The liquid crystal layer may be positioned between the lighting unit and the transparent substrate. The polarizer may be positioned between the liquid crystal layer and the transparent substrate and may include a plurality of conductive members. The conductive members may be electrically conductive, opaque, and spaced from one another. The fillers may include at least one of a plurality of phase difference members formed of a polymer material, a plurality of passivation members formed of an electrically insulating material, and a plurality of gas members formed of a gaseous material. The fillers and the conductive members may be alternately arranged in a direction parallel to the transparent substrate.

This application claims priority to and benefit from Korean Patent Application No. 10-2015-0100847 filed on Jul. 16, 2015 in the Korean Intellectual Property Office; the disclosure of the Korean Patent Application is incorporated herein by reference.

### BACKGROUND

1. Technical Field

The technical field relates to a liquid crystal display device.

2. Description of the Related Art

A liquid crystal display (LCD) device includes a liquid crystal layer for displaying a desired image. By applying an electric field to the liquid crystal layer, an amount of light transmitted through the liquid crystal layer may be adjusted, such that the desired image may be displayed.

### SUMMARY

Embodiments may be related to a liquid crystal display device that can function as a mirror. The liquid crystal display device may include a polarizer that has desirable moisture resistance. The liquid crystal display device may not have significant light leakage.

An embodiment may be related to a display device. The display device may include a lighting unit, a first transparent substrate, a liquid crystal layer, a first polarizer, and a plurality of first-set fillers. The liquid crystal layer may be positioned between the lighting unit and the first transparent substrate. The first polarizer may be positioned between the liquid crystal layer and the first transparent substrate and may include a plurality of first-group conductive members. The first-group conductive members may be electrically conductive, opaque, and spaced from one another. The first-set fillers may include at least one of a plurality of first-set phase difference members formed of a first polymer material, a plurality of first-set passivation members formed of a first electrically insulating material, and a plurality of first-set gas members formed of a first gaseous material (e.g., air). The first-set fillers and the first-group conductive members may be alternately arranged in a direction parallel to the first transparent substrate. The first-group conductive members may directly contact the first transparent substrate. The structures may be appreciated from, for example, FIG. 1, FIG. 2, FIG. 3, FIG. 4, FIG. 5, FIG. 6, FIG. 7, FIG. 8, FIG. 9 and related description in this application.

The first-set fillers may include the first-set phase difference members. The first polymer material may include first-type repeating units, wherein chemical elements in the first-type repeating units may be coplanar.

The first-type repeating units may include at least one of an aromatic ring, a hetero-ring, a ketone group, and an imide group.

The display device may include a first phase difference layer, which may be formed of the first polymer material, may be directly connected to the first-set phase difference members, and may be positioned between the liquid crystal layer and the first polarizer in a direction perpendicular to the first transparent substrate. The first-set fillers may include the first-set phase difference members. The structures may be appreciated from, for example, FIG. 1, FIG. 2, FIG. 5, FIG. 6, FIG. 7, FIG. 8 and related description in this application.

The liquid crystal layer may include liquid crystal molecules having negative dielectric anisotropy. A thickness of a combination of the first phase difference layer and the first-set phase difference members in the direction perpendicular to the first transparent substrate may be in a range of 6 microns to 8 microns.

The display device may include a black matrix, which may directly contact the first phase difference layer and may partially overlap the first phase difference layer. The structures may be appreciated from, for example, FIG. 1, FIG. 2, FIG. 5, FIG. 6, FIG. 7, FIG. 8 and related description in this application.

The display device may include a color filter, which may directly contact each of the first phase difference layer and the black matrix. The structures may be appreciated from, for example, FIG. 5, FIG. 6, and related description in this application.

The display device may include a second polarizer, which may be positioned between the lighting unit and the liquid crystal layer and may include a plurality of second-group conductive members. The second-group conductive members may be electrically conductive, opaque, and spaced from one another. The display device may include a plurality of second-set fillers. The second-set fillers may include at least one of a plurality of second-set phase difference members formed of a second polymer material, a plurality of second-set passivation members formed of a second electrically insulating material, and a plurality of second-set gas members formed of a second gaseous material. The second-set fillers and the second-group conductive members may be alternately arranged in a direction parallel to the liquid crystal layer. The display device may include a second transparent substrate, which may directly contact the second-group conductive members. The structures may be appreciated from, for example, FIG. 1, FIG. 2, FIG. 3, FIG. 4, FIG. 5, FIG. 6, FIG. 7, FIG. 8, FIG. 9 and related description in this application.

The second-set fillers may include the second-set phase difference members. The second polymer material may be identical to the first polymer material and may include repeating units, wherein chemical elements in the repeating units may be coplanar.

The display device may include a first phase difference layer, which may be formed of the first polymer material, may be directly connected to the first-set phase difference members, and may be positioned between the liquid crystal layer and the first polarizer in a direction perpendicular to the first transparent substrate. The first-set fillers may include the first-set phase difference members. The display device may include a second phase difference layer, which may be formed of the second polymer material, may be directly connected to the second-set phase difference members, and may be positioned between the liquid crystal layer and the second polarizer in the direction perpendicular to the first transparent substrate. The second-set fillers may include the second-set phase difference members. The structures may be appreciated from, for example, FIG. 8 and related description in this application.

The liquid crystal layer may include liquid crystal molecules having negative dielectric anisotropy. A thickness of a combination of the first phase difference layer and the first-set phase difference members in the direction perpendicular to the first transparent substrate may be in a range of 3 microns to 4 microns. A thickness of a combination of the second phase difference layer and the second-set phase difference members in the direction perpendicular to the first transparent substrate may be in the range of 3 microns to 4 microns.

The display device may include a first passivation layer, which may be formed of the first electrically insulating material, may be directly connected to the first-set passivation members, and may be positioned between the liquid crystal layer and the first polarizer in a direction perpendicular to the first transparent substrate. The first-set fillers may include the first-set passivation members. The structures may be appreciated from, for example, FIG. 3, FIG. 4, and related description in this application.

The display device may include a first phase difference layer, which may be positioned between the liquid crystal layer and the first passivation layer, may directly contact the passivation layer, and may be formed of a material that includes repeating units. Chemical elements in the repeating units may be coplanar. The display device may include a black matrix, which may directly contact the first phase difference layer and may partially overlap the first phase difference layer. The structures may be appreciated from, for example, FIG. 3, FIG. 4, and related description in this application.

The display device may include a first passivation layer, which may be electrically insulating, may be directly connected to the first-set gas members, and may be positioned between the liquid crystal layer and the first polarizer in a direction perpendicular to the first transparent substrate. The first-set fillers may include the first-set gas members. The display device may include a first phase difference layer, which may be positioned between the liquid crystal layer and the first passivation layer, may directly contact the passivation layer, and may be formed of a material that includes repeating units. Chemical elements in the repeating units may be coplanar. The display device may include a second polarizer, which may be positioned between the lighting unit and the liquid crystal layer. The display device may include a second phase difference layer, which may be positioned between the liquid crystal layer and the second polarizer. A material of the second phase difference layer may be identical to the material of the first phase difference layer. The structures may be appreciated from, for example, FIG. 9 and related description in this application.

The liquid crystal layer may include liquid crystal molecules having negative dielectric anisotropy. A thickness of the first phase difference layer may be in a range of 3 microns to 4 microns. A thickness of the second phase difference layer may be in the range of 3 microns to 4 microns.

A liquid crystal display device according to an embodiment may comprise the following elements: a light source; an upper transparent substrate; a lower transparent substrate disposed between the light source and the upper transparent substrate; a liquid crystal layer disposed between the upper transparent substrate and the lower transparent substrate; a first conductive wire grid polarizing plate which comprises mutually spaced first conductive partition walls, and is disposed between the upper transparent substrate and the liquid crystal layer; and a first phase difference layer which comprises a first-set fillers disposed between the first conductive partition walls, and a first base layer disposed between the first conductive wire grid polarizing plate and the liquid crystal layer and connected to the first-set fillers.

The liquid crystal display device may further comprise the following elements: a second conductive wire grid polarizing plate which comprises second conductive partition walls spaced from each other and is disposed between the lower transparent substrate and the liquid crystal layer; and a second phase difference layer which comprises a second-set fillers disposed between the second conductive partition walls, and a second base layer which is disposed between the second conductive wire grid polarizing plate and the liquid crystal layer and is connected to the second-set fillers.

A liquid crystal display device according to an embodiment may comprise the following elements: a light source; an upper transparent substrate; a lower transparent substrate disposed between the light source and the upper transparent substrate; a liquid crystal layer disposed between the upper transparent substrate and the lower transparent substrate; a first conductive wire grid polarizing plate which comprises mutually spaced first conductive partition walls and air units disposed between the first conductive partition walls, and is disposed between the upper transparent substrate and the liquid crystal layer; a first passivation layer disposed on the first conductive partition walls; and a first phase difference layer disposed between the first passivation layer and the liquid crystal layer.

The liquid crystal display device may further comprise the following elements: a second conductive wire grid polarizing plate which comprises mutually spaced second conductive partition walls and air units disposed between the second conductive partition walls, and is disposed between the lower transparent substrate and the liquid crystal layer; a second passivation layer disposed on the second conductive partition walls; and a second phase difference layer disposed between the second passivation layer and the liquid crystal layer.

The liquid crystal display device may further comprise the following elements: a second conductive wire grid polarizing plate which comprises mutually spaced second conductive partition walls and is disposed between the lower transparent substrate and the liquid crystal layer; a second passivation layer which comprises second-set fillers disposed between the second conductive partition walls, and a second base layer which is disposed between the second conductive wire grid polarizing plate and the liquid crystal layer and is connected to the second-set fillers; and a second phase difference layer disposed between the second passivation layer and the liquid crystal layer.

A liquid crystal display device according to an embodiment may comprise the following elements: a light source; an upper transparent substrate; a lower transparent substrate disposed between the light source and the upper transparent substrate; a liquid crystal layer disposed between the upper transparent substrate and the lower transparent substrate; a first conductive wire grid polarizing plate which comprises mutually spaced first conductive partition walls and is disposed between the upper transparent substrate and the liquid crystal layer; a first passivation layer which comprises first-set fillers disposed between the first conductive partition walls, and a first base layer which is disposed between the first conductive wire grid polarizing plate and the liquid crystal layer and is connected to the first-set fillers; and a first phase difference layer disposed between the first passivation layer and the liquid crystal layer.

The liquid crystal display device may further comprise the following elements: a second conductive wire grid polarizing plate which comprises mutually spaced second conductive partition walls and an air units disposed between the second conductive partition walls, and is disposed between the lower transparent substrate and the liquid crystal layer; a second passivation layer disposed on the second conductive partition walls; and a second phase difference layer disposed between the second passivation layer and the liquid crystal layer.

The liquid crystal display device may further comprise the following elements: a second conductive wire grid polarizing plate which comprises mutually spaced second conductive partition walls and is disposed between the lower transparent substrate and the liquid crystal layer; a second passivation layer which comprises second-set fillers disposed between the second conductive partition walls, and a second base layer which is disposed between the second conductive wire grid polarizing plate and the liquid crystal layer and is connected to the second-set fillers; and a second phase difference layer disposed between the second passivation layer and the liquid crystal layer.

The liquid crystal display device is in a vertical alignment mode.

In the liquid crystal display devices, the liquid crystal layer may comprise liquid crystal molecules that have negative dielectric anisotropy.

In the liquid crystal display devices, at least one of the first phase difference layer and the second phase difference layer may be made of polymer in which all the chemical elements within a repeating unit are disposed on the same plane, such that the repeating unit may have a planar molecular structure. The polymer may contain one or more of an aromatic ring, a hetero-ring, a ketone group, and an imide group in the repeating unit.

In the liquid crystal display devices, at least one of the first phase difference layer and the second phase difference layer may be made of one of parylene and polyimide.

### BRIEF DESCRIPTION OF THE DRAWINGS

FIG. 1 is a schematic cross-sectional view of a liquid crystal display device according to an embodiment.

FIG. 2 illustrates a region A of FIG. 1.

FIG. 3 is a schematic cross-sectional view of a liquid crystal display device according to an embodiment.

FIG. 4 illustrates a region B of FIG. 3.

FIG. 5 is a schematic cross-sectional view of a liquid crystal display device according to an embodiment.

FIG. 6 is a schematic cross-sectional view of a liquid crystal display device according to an embodiment.

FIG. 7 is a schematic cross-sectional view of a liquid crystal display device according to an embodiment.

FIG. 8 is a schematic cross-sectional view of a liquid crystal display device according to an embodiment.

FIG. 9 is a schematic cross-sectional view of a liquid crystal display device according to an embodiment.

### DETAILED DESCRIPTION

Some embodiments are described with reference to the accompanying drawings. The described embodiments may be embodied in many different forms and should not be construed as being limited to the description set forth herein. In the drawings, sizes of layers and regions may be exaggerated for clarity.

Although the terms “first”, “second”, etc. may be used herein to describe various elements, these elements should not be limited by these terms. These terms may be used to distinguish one element from another element. Thus, a first element described in this application may be termed a second element without departing from teachings of one or more embodiments. The description of an element as a “first” element may not require or imply the presence of a second element or other elements. The terms “first”, “second”, etc. may also be used to differentiate different categories or sets of elements. For conciseness, the terms “first”, “second”, etc. may represent, for example, “first-category (or first-set)”, “second-category (or second-set)”, etc., respectively.

When a first element is referred to as being “on”, “connected to”, or “coupled to” a second element, the first element can be directly on, directly connected to, or directly coupled to the second element, or one or more intervening elements may be present. In contrast, when a first element is referred to as being “directly on”, “directly connected to”, or “directly coupled to” a second element, there are no intervening elements intentionally provided between the first element and the second element. Like numbers may refer to like elements in this application. The term “and/or” includes any and all combinations of one or more of the associated items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of embodiments.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

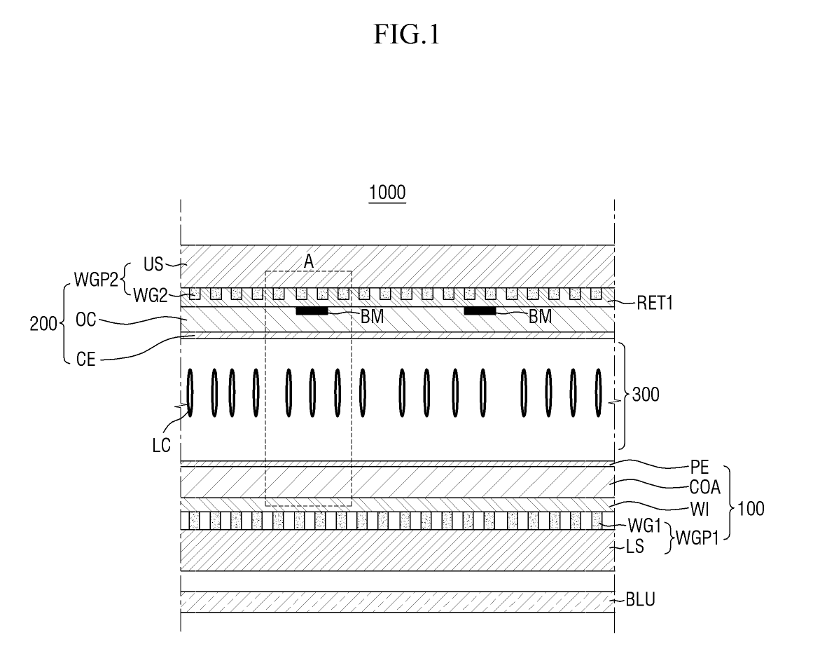

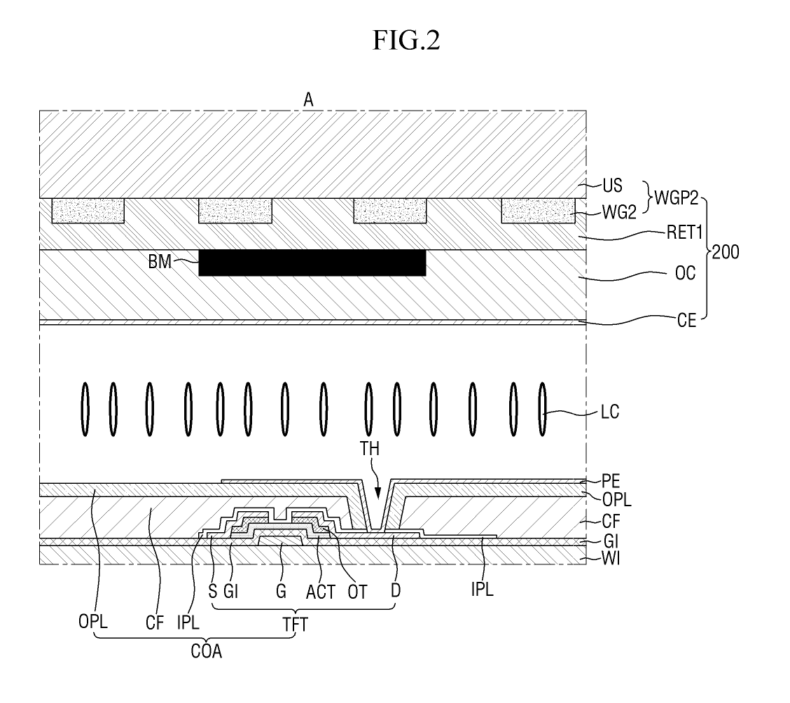

FIG. 1 is a schematic cross-sectional view of a liquid crystal display device 1000 according to an embodiment. FIG. 2 illustrates a region A of FIG. 1.

Referring to FIGS. 1 and 2, the liquid crystal display device 1000 may include a first display substrate 100, a second display substrate 200, and a liquid crystal layer 300 disposed between the first display substrate 100 and the second display substrate 200. For example, the liquid crystal display device 1000 may be a vertical alignment mode liquid crystal display device that has a cell gap of about 3 μm.

The first display substrate 100 may include a first wire grid polarizing plate WGP1, an insulating film WI, a color filter-on-array layer COA, and a pixel electrode PE. The first wire grid polarizing plate WGP1 may include a first transparent substrate LS and a first conductive wire grid pattern layer WG1 (or polarizer WG1). The first transparent substrate LS is capable of transmitting visible light. The first transparent substrate LS may be formed of, for example, at least one of glass, quartz, polyethersulphone (PES), polyacrylate (PA), polyarylate (PAR), polyetherimide (PEI), polyethylene napthalate (PEN), polyethylene terepthalate (PET), polyphenylene sulfide (PPS), polyallylate, polyimide (PI), polycarbonate (PC), cellulose triacetate (CAT or TAC), cellulose acetate propionate (CAP), and the like.

The first conductive wire grid pattern layer WG1 may include opaque electrically conductive members, or opaque conductive partition walls, that are disposed on the first transparent substrate LS and are spaced at a predetermined interval. The first wire grid polarizing plate WGP1 may transmit a first component of the incident light and may reflect a second component of the light that is perpendicular to the first component of the light. The electrical conductivity of the conductive partition walls may facilitate reflection of the second component of the light. Air may be filled in the slits between the conductive partition walls.

For example, the conductive partition walls may have a line width of approximately 50 nm or less, a thickness of approximately 150 nm or higher, and a spaced pitch of approximately 100 nm.

The first conductive wire grid pattern layer WG1 may be made of an electrically conductive material. For example, the first conductive wire grid pattern layer WG1 may be made of metal, and for example, the metal may be one of aluminum (Al), chromium (Cr), silver (Ag), copper (Cu), nickel (Ni), titanium (Ti), cobalt (Co), molybdenum (Mo) and alloys of these elements. The metal may be non-ferrous, such that the performance and durability of the first conductive wire grid pattern layer WG1 may not be significantly affected by moisture.

In some cases, the first conductive wire grid pattern layer WG1 may have a multi-layered structure including two or more layers. For example, a first layer (not shown) may be formed of aluminum, and a second layer (not shown) may be formed of titanium or molybdenum. When the first layer (not shown) is aluminum, a hillock may occur depending on the process temperature of the subsequent process, and an upper surface may become uneven. A second layer (not shown) made of titanium or molybdenum may be formed on a first layer (not shown) to prevent undesirable effects associated with the hillock.

The insulating film WI may be disposed between the first conductive wire grid pattern layer WG1 and the color filter-on-array layer COA to insulate them. The insulating film WI may be made of an inorganic material, such as silicon nitride and/or silicon oxide.

The color filter-on-array layer COA may include a thin film transistor TFT, a color filter layer CF and an organic passivation layer OPL. In the thin film transistor TFT, the gate electrode G is disposed on the insulating film WI, and the gate insulating film GI is disposed on the gate electrode G. On the gate insulating film GI, the semiconductor layer ACT is located in a region which at least partially overlaps the gate electrode G, ohmic contact layers OL disposed to be spaced apart from each other are disposed on the semiconductor layer ACT, and each of a source electrode S and a drain electrode D is located on the ohmic contact layer OL. An inorganic passivation layer IPL is located on the gate insulating film GI, the source electrode S, the semiconductor layer ACT and the drain electrode D, and the color filter layer CF is disposed on the inorganic passivation layer IPL. The organic passivation layer OPL may be disposed on the color filter layer CF, and the pixel electrode PE may be disposed on the organic passivation layer OPL. A contact hole TH may be formed on the color filter layer CF and the organic passivation layer OPL, and the pixel electrode PE may be electrically connected to the drain electrode D through the contact hole TH.

The pixel electrode PE is an electric field generating electrode and may be disposed on the color filter-on-array layer COA. The pixel electrode PE may be formed of a transparent conductive oxide such as ITO or IZO.

The second display substrate 200 may include a second conductive wire grid polarizing plate WGP2, a first phase difference layer RET1, an overcoat layer OC, a common electrode CE, and a black matrix BM.

The second wire grid polarizing plate WGP2 may include a second transparent substrate US and a second conductive wire grid pattern layer WG2 (or polarizer WG2) disposed on the second transparent substrate US. The second conductive wire grid polarizing plate WGP2 may enable a mirror function of the liquid crystal display device 1000 by reflecting an external incident light.

The second transparent substrate US is capable of transmitting visible light, and its material may be selected depending on the applications and processes.

The second conductive wire grid pattern layer WG2, or polarizer WG2, may include opaque electrically conductive partition walls that are disposed on the second transparent substrate LS and are spaced apart from each other at a predetermined interval. The polarizer WG2 may transmit a first component of an incident light and may reflect a second component of the incident light that is perpendicular to the first component of the incident light. For example, the conductive partition walls may have a line width of approximately 50 nm or less, a thickness of approximately 150 nm or more, and a spaced pitch of approximately 100 nm.

The second conductive wire grid pattern layer WG2 may be made of a conductive material. The conductive material may be identical to or different from the material of the first conductive wire grid pattern layer WG1. For example, the second conductive wire grid pattern layer WG2 may be made of a metal. For example, the metal may be one of aluminum (Al), chromium (Cr), silver (Ag), copper (Cu), nickel (Ni), titanium (Ti), cobalt (Co), molybdenum (Mo), and an alloy of one or more of the above metal materials. The electrical conductivity of the second conductive wire grid polarizing layer WG2 may facilitate light reflection. The metallic second conductive wire grid polarizing layer WG2 may have excellent moisture resistance. Advantageously, the performance (e.g., the mirror function), reliability, and/or durability of the liquid crystal display device 1000 may be satisfactory.

In some cases, the second conductive wire grid pattern layer WG2 may have a multi-layered structure including two or more layers. For example, a first layer (not shown) may be formed of aluminum, and a second layer (not shown) may be formed of titanium or molybdenum.

The first phase difference layer RET1 may minimize or substantially prevent side light leakage of the liquid crystal display device 1000 (which may operate in a vertical alignment mode). The first phase difference layer RET1 may include first-set fillers disposed in the slits between the conductive partition walls and may include a first base layer connected to the first-set fillers. The first base layer may be disposed between the second conductive wire grid pattern layer WG2 and an overcoat layer OC and may directly contact each of the layers WG2 and OC.

The first phase difference layer RET1 may be made of polymer in which all the chemical elements in each repeating unit are substantially coplanar, such that the repeating unit may have a planar molecular structure. For example, the polymer may contain one or more of an aromatic ring, a hetero-ring, a ketone group, and an imide group in the repeating unit. The polymer may be, for example, one of parylene and polyimide. For example, the parylene may be one or more of parylene N, parylene C, and parylene D. For example, the polyimide may be an aromatic polyimide.

The first phase difference layer RET1 may not significantly affect the degree of polarization of the second conductive wire grid polarizing plate WGP2. In an experiment, the degree of polarization in an embodiment with the first phase difference layer RET1 directly deposed on the second conductive wire grid polarizing plate WGP2 is measured, the degree of polarization in an embodiment with no phase difference layer RET1 directly deposed on the second conductive wire grid polarizing plate WGP2 is measured, and the result values are compared. With the first phase difference layer RET1 directly deposed on the second conductive wire grid polarizing plate WGP2, the degree of polarization DOP is 0.994. With no phase difference layer RET1 directly deposed on the second conductive wire grid polarizing plate WGP2, the degree of polarization DOP is 0.995. The difference is not significant.

For example, the first phase difference layer RET1 may be formed of parylene on the second conductive wire grid polarizing plate WGP2 using a chemical vapor deposition method. The thickness of the first phase difference layer RET1 may depend on the deposition thickness of parylene.

For example, the thickness of the first phase difference layer RET1 may be in a range of 6 μm to 8 μm, such that the first phase difference layer RET1 may effectively minimize or substantially prevent side light leakage.

A black matrix BM may be disposed on the first phase difference layer RET1 in a region that overlaps the thin film transistor TFT. The overcoat layer OC may be disposed between the first phase difference layer RET1 and the common electrode CE, and may cover the black matrix BM.

The common electrode CE is an electric field generating electrode, may be formed on (a substantially flat surface of) the overcoat layer OC, and may be formed of a transparent conductive oxide, such as ITO or IZO.

The liquid crystal layer 300 serves to control transmission of the incident light. The liquid crystal layer 300 may include liquid crystal molecules LC having negative dielectric anisotropy. For example, the liquid crystal layer 300 may have a refractive index anisotropy value (Δn) in range of 0.09 to 0.11.

The liquid crystal display device 1000 may further include a lighting unit, e.g., a backlight unit BLU, positioned below first display substrate 100 for providing light toward the substrate 100. The backlight unit BLU may include one or more of a light guide plate (not shown), a light source (not shown), a reflecting member (not shown), an optical sheet (not shown), etc. The display 1000 may display an image on the second display substrate 200. That is, an image may be viewed at the second transparent substrate US.

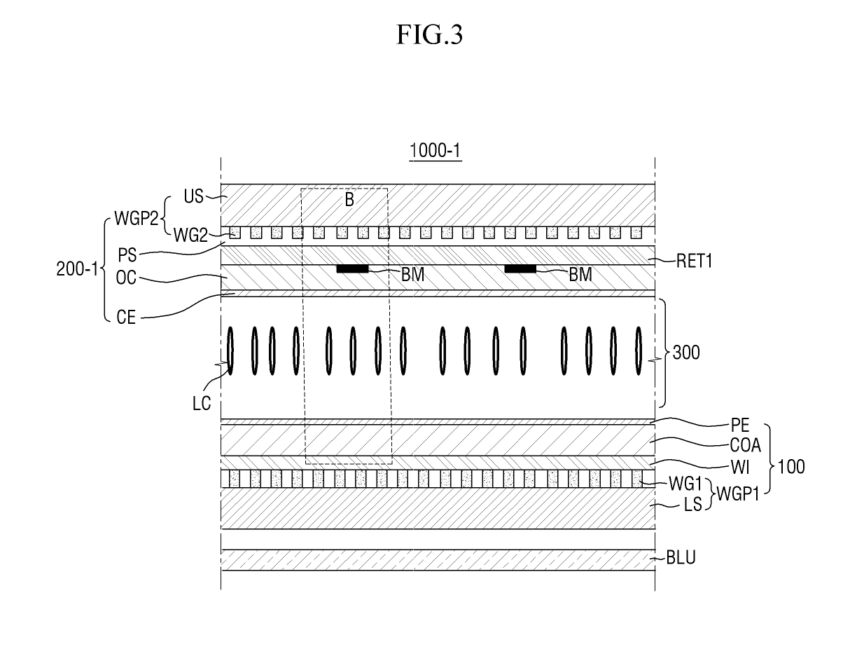

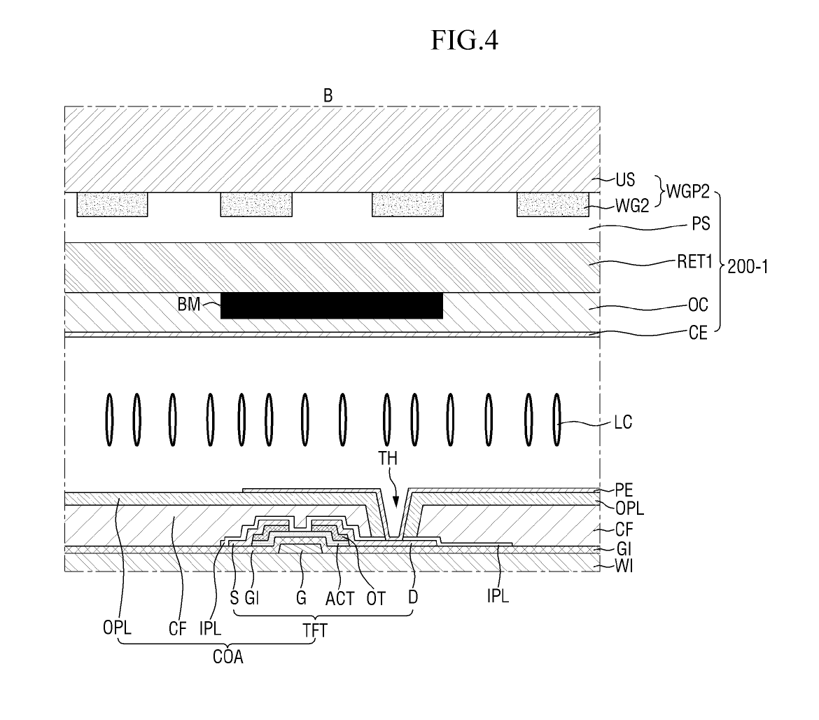

FIG. 3 is a schematic cross-sectional view of a liquid crystal display device 1000-1 according to an embodiment. FIG. 4 illustrates a region B of FIG. 3.

The liquid crystal display device 1000-1 is different from the liquid crystal display device 1000 in that it includes a display substrate 200-1. The display substrate 200-1 is different from the second display substrate 200 in that the display substrate 200-1 includes a passivation layer PS. The passivation layer PS includes fillers disposed between the conductive partition walls constituting the second conductive wiring pattern layer WG2 and includes a base layer connected to the fillers. A first phase difference layer RET1 is disposed between the passivation layer PS and the overcoat layer OC. The fillers and the base layer may be formed of an electrically insulating material. For example, the passivation layer PS may be formed by depositing an inorganic material, such silicon nitride and/or silicon oxide.

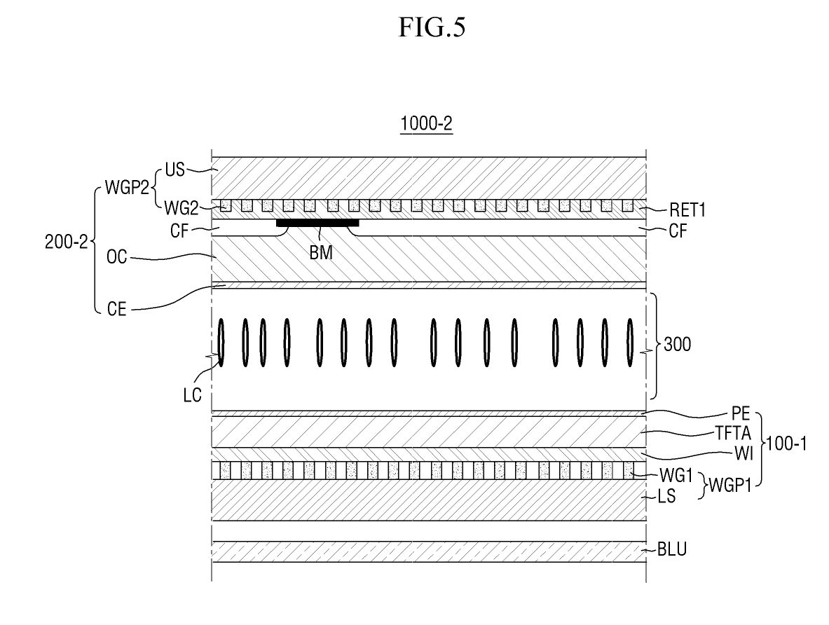

FIG. 5 is a schematic cross-sectional view of a liquid crystal display device 1000-2 according to an embodiment.

The liquid crystal display device 1000-2 is different from the liquid crystal display device 1000 in that it includes a display substrate 200-2. The display substrate 200-2 includes a color filter CF, and an overcoat layer OC may be disposed on a black matrix BM and the color filter CF.

The liquid crystal display device 1000-2 is different from the liquid crystal display device 1000 in that the display substrate 100-1 does not include a color filter-on-array layer. In the liquid crystal display device 1000-2, the display substrate 100-1 may include a switching element array layer TFTA. In the switching element array layer TFTA, a thin film transistor TFT may be covered with an organic passivation layer. The switching element array layer TFTA may be disposed between the insulating film WI and the pixel electrode PE.

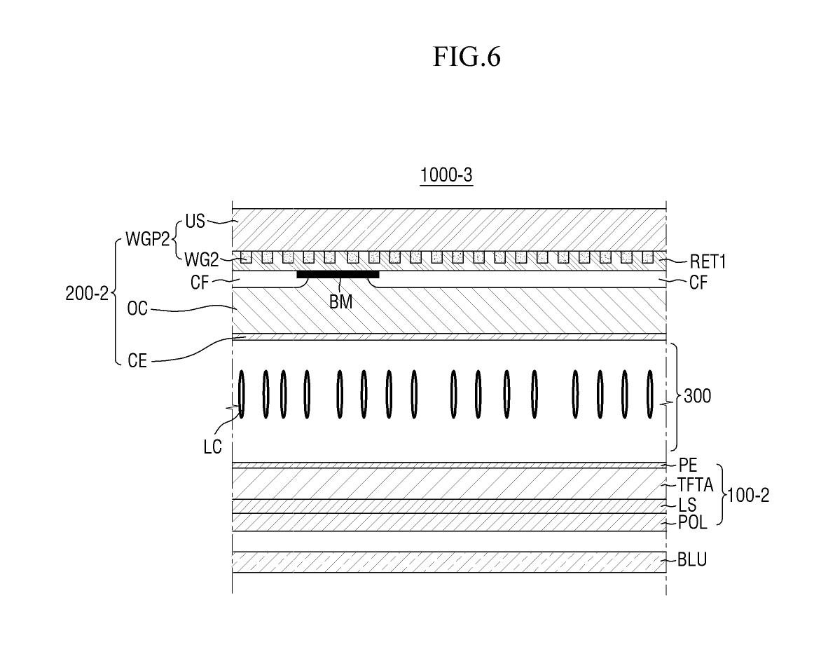

FIG. 6 is a schematic cross-sectional view of a liquid crystal display device 1000-3 according to an embodiment.

The liquid crystal display device 1000-3 is different from the liquid crystal display device 1000-2 in that it includes a display substrate 100-2. The display substrate 100-2 is different from the display substrate 100-1 in that the display substrate 100-2 does not include a first conductive wire grid polarizing plate WGP1. The display substrate 100-2 includes a polyvinyl alcohol (PVA) polarizing film POL instead of a first conductive wire grid polarizing plate WGP1, and the polyvinyl alcohol polarizing film POL may be disposed below a first transparent substrate LS. The first transparent substrate LS may be disposed between a switching element array layer TFTA and the polyvinyl alcohol polarizing film POL.

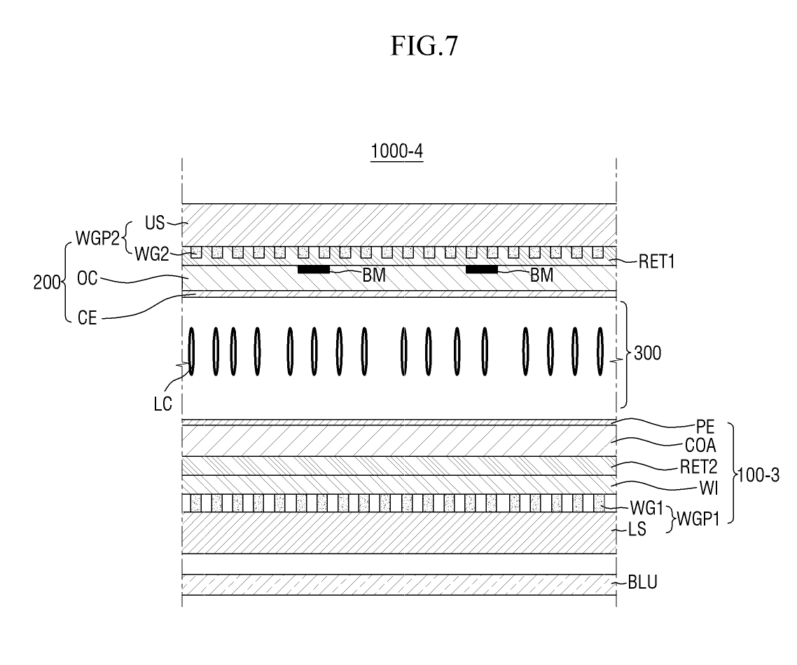

FIG. 7 is a schematic cross-sectional view of a liquid crystal display device 1000-4 according to an embodiment.

The liquid crystal display device 1000-4 is different from the liquid crystal display device 1000 in that the liquid crystal display device 1000-4 includes a display substrate 100-3. The display substrate 100-3 is different from the first display substrate 100 in that the display substrate 100-3 includes a substantially planar second phase difference layer RET2 disposed between an insulating film WI and a color filter-on-array layer COA. The second phase difference layer RET2 may be a substantially planar layer without significant protrusions. In the substrate 100-3, gaseous fillers (e.g., air units) and electrically conductive members of a polarizer WG1 may be alternately arranged in a direction parallel to a transparent substrate LS. In the substrate 100-3, an insulating film WI may be positioned between the polarizer WG1 and the layer RET2 and may directly contact each of the polarizer WG1 and the layer RET2.

The second phase difference layer RET2 may be formed of polymer in which all the chemical elements in a repeating unit are coplanar, such that the repeating unit may have a planar molecular structure. The material of the layer second phase difference layer RET2 may be identical to or different from the material of in the first phase difference layer RET1. For example, the polymer may contain one or more of an aromatic ring, a hetero-ring, a ketone group, and an imide group in the repeating unit. The polymer may be/include, for example, one or more of parylene and polyimide. For example, the parylene may be/include one or more of parylene N, parylene C, and parylene D. For example, the polyimide may be an aromatic polyimide. For example, the maximum thickness of the first phase difference layer RET1 in a direction perpendicular to the substrate US may be in a range of 3 μm to 4 μm, and the maximum thickness of the second phase difference layer RET2 in the direction perpendicular to the substrate US may be in the range of 3 μm to 4 μm, such that the first phase difference layer RET1 and the second phase difference layer RET2 may effectively minimize or substantially prevent side light leakage.

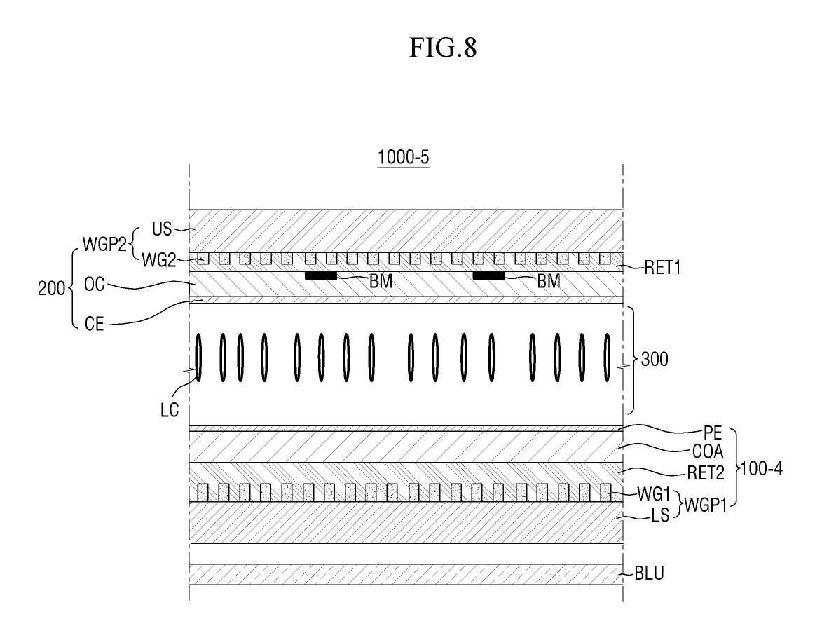

FIG. 8 is a schematic cross-sectional view of a liquid crystal display device 1000-5 according to an embodiment.

The liquid crystal display device 1000-5 is different from the liquid crystal display device 1000-4 in that the liquid crystal display device 1000-5 includes a display substrate 100-4. The display substrate 100-4 is different from display substrate 100-3 in that the display substrate 100-4 includes a second phase difference layer RET2 with fillers and a base layer.

The second phase difference layer RET2 may include polymer fillers and a polymer base layer. The polymer fillers are directly connected to the polymer base layer and are disposed in the slits between the mutually spaced electrically conductive members of a polarizer WG1. The polymer fillers and the electrically conductive members are alternately arranged. The polymer base layer may be disposed between the polarizer WG1 and a color filter-on-array layer COA and may directly contact each of the polarizer WG1 and the layer COA.

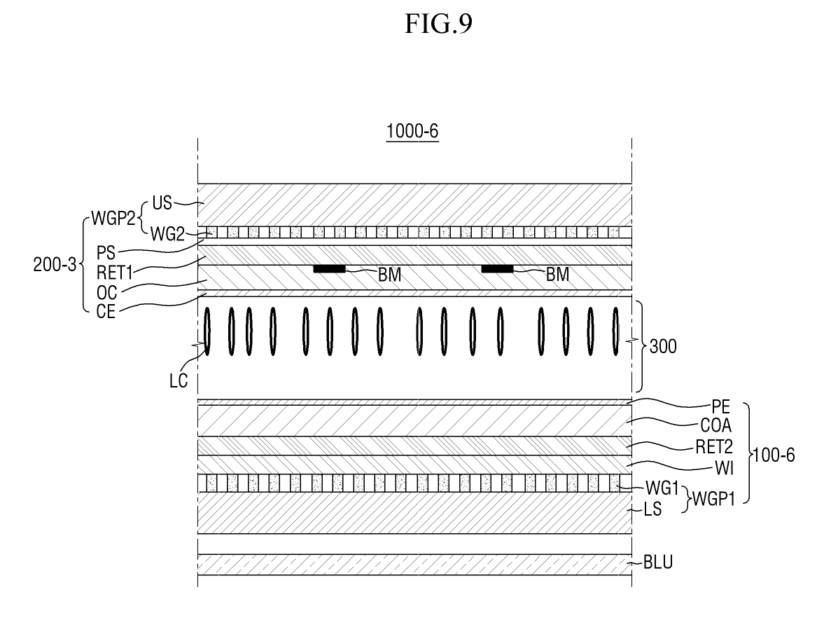

FIG. 9 is a schematic cross-sectional view of a liquid crystal display device 1000-6 according to an embodiment.

The liquid crystal display device 1000-6 is different from the liquid crystal display device 1000-4 in that the liquid crystal display device 1000-6 includes a display substrate 200-3. The display substrate 200-3 is different from the second display substrate 200 in that the display substrate 200-3 includes a substantially planar passivation layer PS that directly contact electrically conductive members of a polarizer WG2 and that a substantially planar first phase difference layer RET1 is disposed between the passivation layer PS and an overcoat layer OC. For example, the passivation layer PS may be formed by depositing at least one of silicon nitride, silicon oxide, etc. Gaseous fillers (e.g., air units) may be positioned between the electrically conductive members of the polarizer WG2 and may be directly connected to the passivation layer PS.

The substrate 100-6 of the liquid crystal display device 1000-6 may be substantially identical to or analogous to the substrate 100-3 of the liquid crystal display device 1000-4.

It will be apparent to those skilled in the art that various modifications and variation can be made in the described embodiments. The described embodiments cover modifications and variations within the scope defined by the appended claims and their equivalents.

What is claimed is:

1. A display device comprising:
a lighting unit;
a first transparent substrate;
a liquid crystal layer positioned between the lighting unit and the first transparent substrate;
a first polarizer, which is positioned between the liquid crystal layer and the first transparent substrate and comprises a plurality of first-group conductive members, wherein the first-group conductive members are electrically conductive, are opaque, and are spaced from one another; and
a plurality of first-set fillers, wherein the first-set fillers comprise at least one of a plurality of first-set phase difference members formed of a first polymer material, a plurality of first-set passivation members formed of a first electrically insulating material, and a plurality of first-set gas members formed of a first gaseous material, and wherein the first-set fillers and the first-group conductive members are alternately arranged in a direction parallel to the first transparent substrate.

2. The display device of claim 1, wherein the first-group conductive members directly contact the first transparent substrate.

3. The display device of claim 1, wherein the first-set fillers comprise the first-set phase difference members, and wherein the first polymer material comprises first-type repeating units, wherein chemical elements in the first-type repeating units are coplanar.

4. The display device of claim 3, wherein the first-type repeating units comprise at least one of an aromatic ring, a hetero-ring, a ketone group, and an imide group.

5. The display device of claim 1 comprising: a first phase difference layer, which is formed of the first polymer material, is directly connected to the first-set phase difference members, and is positioned between the liquid crystal layer and the first polarizer in a direction perpendicular to the first transparent substrate, wherein the first-set fillers comprise the first-set phase difference members.

6. The display device of claim 5, wherein the liquid crystal layer comprises liquid crystal molecules having negative dielectric anisotropy, wherein a thickness of a combination of the first phase difference layer and the first-set phase difference members in the direction perpendicular to the first transparent substrate is in a range of 6 microns to 8 microns.

7. The display device of claim 5 comprising: a black matrix directly contacting the first phase difference layer and partially overlapping the first phase difference layer.

8. The display device of claim 7 comprising: a color filter directly contacting each of the first phase difference layer and the black matrix.

9. The display device of claim 1 further comprising:
a second polarizer, which is positioned between the lighting unit and the liquid crystal layer and comprises a plurality of second-group conductive members, wherein the second-group conductive members are electrically conductive, are opaque, and are spaced from one another; and
a plurality of second-set fillers, wherein the second-set fillers comprise at least one of a plurality of second-set phase difference members formed of a second polymer material, a plurality of second-set passivation members formed of a second electrically insulating material, and a plurality of second-set gas members formed of a second gaseous material, and wherein the second-set fillers and the second-group conductive members are alternately arranged in a direction parallel to the liquid crystal layer.

10. The display device of claim 9 comprising: a second transparent substrate, which directly contact the second-group conductive members.

11. The display device of claim 9, wherein the second-set fillers comprise the second-set phase difference members, and wherein the second polymer material is identical to the first polymer material and comprises repeating units, wherein chemical elements in the repeating units are coplanar.

12. The display device of claim 9 comprising:
a first phase difference layer, which is formed of the first polymer material, is directly connected to the first-set phase difference members, and is positioned between the liquid crystal layer and the first polarizer in a direction perpendicular to the first transparent substrate, wherein the first-set fillers comprise the first-set phase difference members; and
a second phase difference layer, which is formed of the second polymer material, is directly connected to the second-set phase difference members, and is positioned between the liquid crystal layer and the second polarizer in the direction perpendicular to the first transparent substrate, wherein the second-set fillers comprise the second-set phase difference members.

13. The display device of claim 12, wherein the liquid crystal layer comprises liquid crystal molecules having negative dielectric anisotropy, wherein a thickness of a combination of the first phase difference layer and the first-set phase difference members in the direction perpendicular to the first transparent substrate is in a range of 3 microns to 4 microns, and wherein a thickness of a combination of the second phase difference layer and the second-set phase difference members in the direction perpendicular to the first transparent substrate is in the range of 3 microns to 4 microns.

14. The display device of claim 1 comprising: a first passivation layer, which is formed of the first electrically insulating material, is directly connected to the first-set passivation members, and is positioned between the liquid crystal layer and the first polarizer in a direction perpendicular to the first transparent substrate, wherein the first-set fillers comprise the first-set passivation members.

15. The display device of claim 14 comprising: a first phase difference layer, which is positioned between the liquid crystal layer and the first passivation layer, directly contacts the passivation layer, and is formed of a material that comprises repeating units, wherein chemical elements in the repeating units are coplanar.

16. The display device of claim 15 comprising: a black matrix directly contacting the first phase difference layer and partially overlapping the first phase difference layer.

17. The display device of claim 1 comprising: a first passivation layer, which is electrically insulating, is directly connected to the first-set gas members, and is positioned between the liquid crystal layer and the first polarizer in a direction perpendicular to the first transparent substrate, wherein the first-set fillers comprise the first-set gas members.

18. The display device of claim 17 comprising: a first phase difference layer, which is positioned between the liquid crystal layer and the first passivation layer, directly contacts the passivation layer, and is formed of a material that comprises repeating units, wherein chemical elements in the repeating units are coplanar.

19. The display device of claim 18 comprising:
a second polarizer, which is positioned between the lighting unit and the liquid crystal layer; and
a second phase difference layer, which is positioned between the liquid crystal layer and the second polarizer, wherein a material of the second phase difference layer is identical to the material of the first phase difference layer.

20. The display device of claim 19, wherein the liquid crystal layer comprises liquid crystal molecules having negative dielectric anisotropy, wherein a thickness of the first phase difference layer is in a range of 3 microns to 4 microns, and wherein a thickness of the second phase difference layer is in the range of 3 microns to 4 microns.
